(19) United States
(12) Patent Application Publication
(10) Pub. No.: US 2001/0047399 A1
(43) Pub. Date: Nov. 29, 2001

(54) Network folder system

(75) Inventor: Matumi Yamahashi, Tokyo (JP)

Correspondence Address: ARENT FOX KINTNER PLOTKIN & KAHN, PLLC, 1050 Connecticut Avenue, N.W., Suite 600, Washington, DC, 20036-5339, US

(73) Assignee: PUTI SOFT, INC.

(21) Appl. No.: 09/725,509

(22) Filed: Nov. 30, 2000

(30) Foreign Application Priority Data
May 23, 2000 (JP) 2000-151371

(51) Int. Cl. G06F 15/16; G06F 15/173

(52) U.S. Cl. 709/219; 709/225

(57) ABSTRACT

Disclosed is a network folder system comprising a combination network in which a plurality of servers are so connected that the servers may supplement their data and information with each other. The combination network has a plurality of client terminal units connected thereto. Each of the servers has an on-line folder equipped therewith for storing data and/or pieces of information, which otherwise, would be stored on the client side. Each terminal unit can download and upload data and/or information to a selected server or servers. Thus, lots of data and information can be stored in a selected on-line folder or folders, accordingly reducing the loading of the terminal unit, and at the same time, permitting other clients to use such data and information in common.

### BACKGROUND OF THE INVENTION

1. Field of the Invention

The present invention relates to a network folder system, and particularly to a network folder system whose servers permit terminal units to upload data and/or information to selected servers for storage in place of storing such data and/or information on clients's side.

2. Related Arts

Usually a provider is responsive to a request from a selected client terminal unit for making a required connection to a desired server, thereby allowing the client terminal unit to download desired data or information from the server. The so downloaded data and/or information may be stored on the client's side, for instance, in hard disks.

Client terminal units are designed to store data and/or information in their inner or exterior storage means, such as hard disks. Disadvantageously as the amount of data stored in the client terminal unit increases, the access time per se on the client's side is extended. Still disadvantageously, less important pieces of information stored on the client side prevents the terminal unit from working to the full.

There has been, therefore, an increasing demand for storing a large amount of information without lowering the efficiency of the client terminal unit.

### SUMMARY OF THE INVENTION

To meet such demand a network folder system comprising a combination network in which a plurality of servers are so connected that they may supplement their data and information with each other, allowing a plurality of client terminal units to access to selected servers, is improved according to the present invention in that each of said servers has an on-line folder equipped therewith for storing data and/or information, which otherwise, would be stored on the client's side.

The combination network may be connected to the internet by protocol conversion.

Each of the terminal units may comprise means responsive to its start for downloading data and/or information from a selected server or servers.

Each of the terminal units may further comprise means for uploading data and/or information from its memory to a selected server or servers during its operation or at the end of its operation.

Other objects and advantages of the present invention will be understood from the following description of a network folder system according to the present invention, which is shown in accompanying drawings.

### BRIEF DESCRIPTION OF THE DRAWING

FIG. 1 illustrates a network folder system according to the present invention;

FIG. 2 is a flowchart showing a series of actions taken by a client terminal unit in setting up for downloading from selected on-line folders in the combination network; and

FIG. 3 is a flowchart showing another series of actions taken by the client terminal unit for uploading to selected on-line folders in the combination network.

### DETAILED DESCRIPTION OF PREFERRED EMBODIMENT

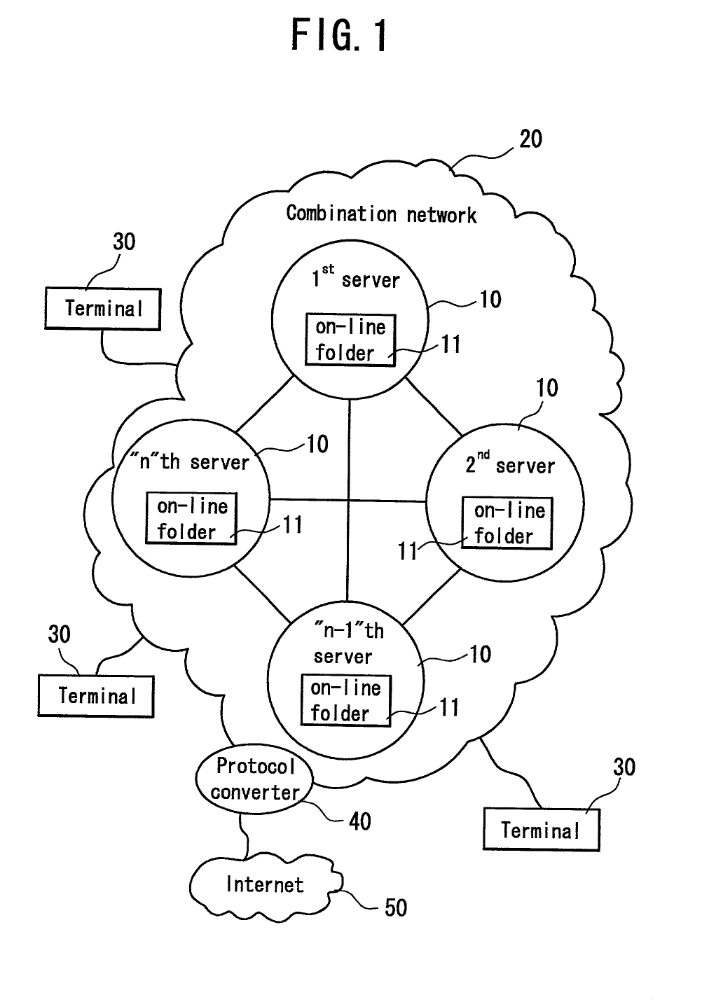

Referring to FIG. 1, a combination network 20 includes the first, the second—the “n−1”th and the “n”th servers 10, which are so connected that the servers 10 may supplement their data and information with each other. The combination network 20 has client terminal units 30 connected thereto. The combination network 20 can be connected to the internet 50 via a protocol converter 40. The client terminal unit 30 is a personal computer or any other information device capable of accessing to a selected server in the combination network 20.

Each server 10 is equipped with an on-line folder 11 for storing data and/or information, which otherwise, would be stored on the client's side. Every on-line folder has a backup function relative to each other. While each of the servers 10 is monitoring the working conditions of the others to make a decision on which server's burden be shifted to another backup server, the shifting of such burden is conducted. Every terminal unit 30 is allowed to retrieve desired data and/or information simply by accessing to the combination network 20.

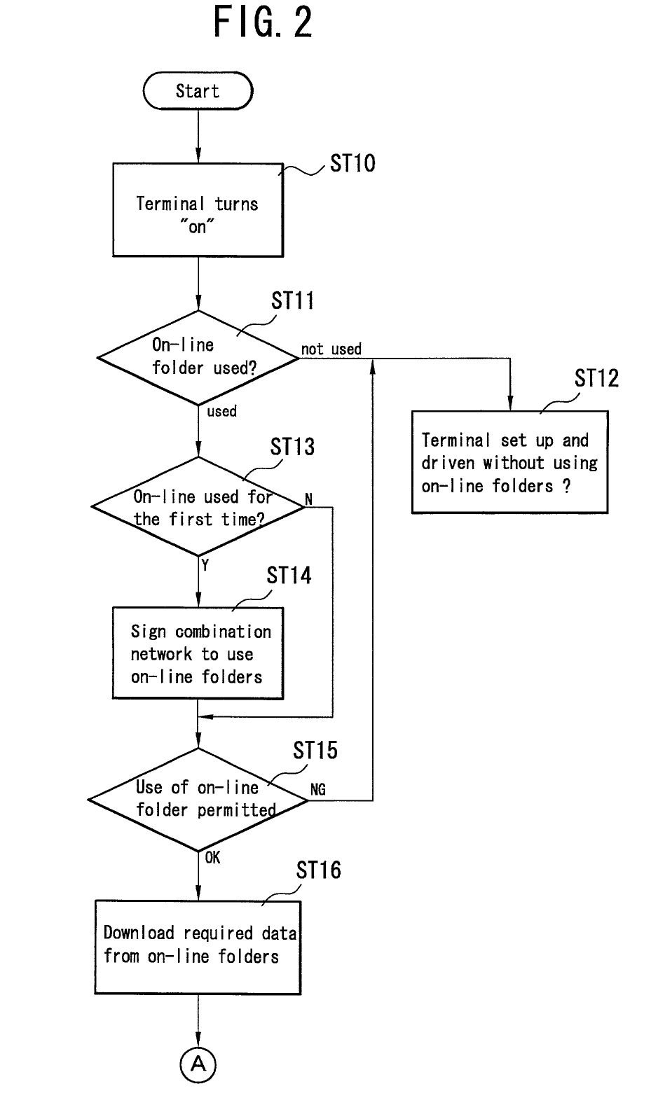

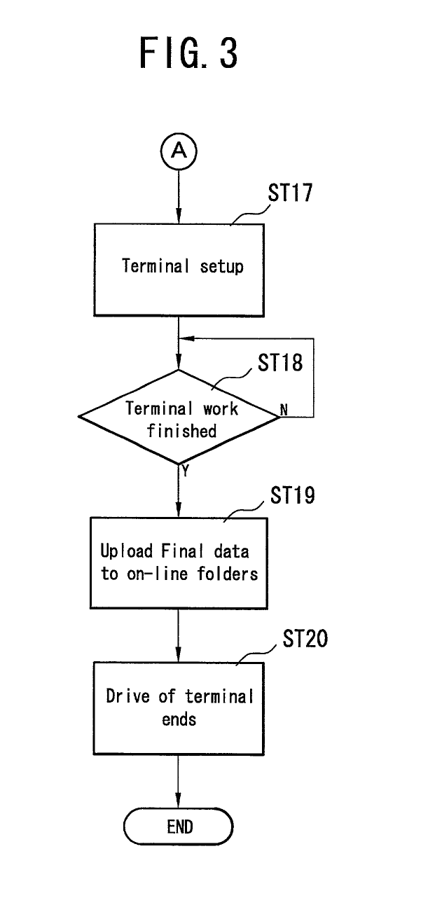

Referring to FIGS. 2 and 3 along with FIG. 1, the manner in which the network folder system works is described.

Referring to FIG. 2, first, a selected client terminal unit 30 is made to turn on (ST 10), and then, a decision is made as to whether the on-line folder 11 is used or not (ST 11).

In the negative case the terminal unit 30 is set up for storing data and/or

In the affirmative case, that is, if choice is made of use of the on-line folder 11 at ST 11, a decision is made as to whether the on-line folder is used for the first time (ST 13).

In the affirmative case the terminal unit 30 signs the combination network 20 to use a selected on-line folder 11 (ST 14).

If use of the on-line folder is not permitted, the normal set-up and drive is effected, thereby permitting the terminal unit 30 to store data and/or information in its built-in memory medium (ST 15 and ST 12).

If use of the on-line folder 11 is permitted at ST 15, the terminal unit 30 has an access to a selected on-line folder 11 for downloading required data and/or information (ST 16). The combination network 20 manages all on-line folders 11, realizing which on-line folder stores what data and/or information. The terminal unit 30, therefore, can have required data and/or information simply by requesting an access to the on-line folder 20.

Referring to FIG. 3, after completing the setup of the terminal unit 30, the terminal unit 30 is put in operation, allowing data and/or information provided during operation to be stored in its built-in memory or storage medium (ST 17 and ST 18). If the data should be increased to the inhibitable amount, the overflowing amount of data will be shifted to the on-line folder 11.

When the terminal unit 30 finishes its work, the terminal unit 30 uploads to the online folder all of the final data and/or information provided during its operation, thus finishing a series of actions taken by the terminal unit 30 (ST 19 and ST 20).

As may be understood from the above, lots of data and information can be stored in a selected on-line folder or folders 11 in the combination network 20, accordingly reducing the loading of the terminal unit 30, and at the same time, permitting other terminal units 30 to use such data and pieces of information in common via the combination network.

The terminal unit 30 can have an improved access capability by shifting the burdening of the terminal unit to the on-line folder 11, and still advantageously, the terminal unit 30 need not be equipped with an increased capacity of memory.

The shifting of data and/or information to a selected on-line folder or folders permits common use of such data and information by all clients, who are living in different districts. Thus, the necessity of transporting such data and/or information is eliminated.

What is claimed is:

1. A network folder system comprising a combination network in which a plurality of servers are so connected that they may supplement their data and information with each other, allowing a plurality of client terminal units to access to selected servers, characterized in that each of said servers has an on-line folder equipped therewith for storing data and/or information, which otherwise, would be stored on the client's side.

2. A network folder system according to claim 1 wherein the combination network can be connected to the internet by protocol conversion.

3. A network folder system according to claim 1 wherein each of the terminal units comprises means responsive to its start for downloading data and/or pieces of information from a selected server or servers.

4. A network folder system according to claim 1 or 3 wherein each of the terminal units further comprises means for uploading data and/or pieces of information from its memory to a selected server or servers during its operation and/or at the end of its operation.
